(19) United States
(12) Patent Application Publication
(10) Pub. No.: US 2015/0267723 A1
(43) Pub. Date: Sep. 24, 2015

(54) GAS CYLINDER

(71) Applicant: SAMHONGSA CO., LTD, Seoul (KR)

(72) Inventor: Min Jae Kim, Seoul (KR)

(21) Appl. No.: 14/665,595

(22) Filed: Mar. 23, 2015

(30) Foreign Application Priority Data
Mar. 24, 2014 (KR) 10-2014-0034081

(51) Int. Cl. F15B 15/14

(52) U.S. Cl. CPC F15B 15/1447

(57) ABSTRACT

A gas cylinder is presented. The gas cylinder may include a base tube including a hollow section, a spindle which is inserted into the hollow section and generates an up-and-down, reciprocating movement along an inside circumferential surface of the base tube, a spindle guide which is installed between the base tube and the spindle, and guides a moving path of the spindle, and a reinforcement unit installed inside the spindle guide.

### RELATED APPLICATION

This application claims the benefit of Korean Patent Application No. 10-2014-0034081, filed on Mar. 24, 2014, in the Korean Intellectual Property Office, the disclosure of which is incorporated herein in its entirety by reference.

### BACKGROUND

1. Field

One or more exemplary embodiments relate to a gas cylinder.

2. Description of the Related Art

In general, a gas cylinder applied to a chair mainly includes a base tube and a gas spindle where the spindle of the gas cylinder moves up and down for controlling the height of a chair seat.

FIG. 9 is a cross-sectional view illustrating the structure of a conventional gas cylinder.

Referring to FIG. 9, the conventional gas cylinder 10 may include a spindle 13 connected to a bottom surface of a chair seat, a base tube 11 supporting the spindle 13, and a tube guide 12, which is inserted between the base tube 11 and the spindle 13 and guides the spindle 13 so that the spindle 13 may not sway sideways while moving up and down.

In detail, the gas cylinder 10 may include a piston 23 which travels in a relative up-and-down reciprocating movement inside the spindle 13, a piston rod 22 where the piston 23 is installed, and a cylinder 16 which is inserted into the inside circumferential surface of the spindle 13 and surface-contacts an O-ring installed on the outside circumferential surface of the piston 23. Here, the cylinder 16 is divided into two parts by the piston 23; an upper chamber 20 and a lower chamber 21.

In addition, the gas cylinder 10 may include a gas sealing unit 24 sealing the bottom end portion of the cylinder 16, a pipe holder 17 sealing the top end portion of the cylinder 16, a switching pin 15 inserted through the center portion of the pipe holder 17, and an open pin 14 controlling the opening and closing of the switching pin 15 by an up-and-down movement.

In detail, an orifice 18 may be formed on one side of the pipe holder 17 for the gas movement, and is opened and closed by the switching pin 15. In addition, a gas flow path 19, along which the gas exhausted through the orifice 18 moves, may be formed between the cylinder 16 and the spindle 13.

The function of the conventional gas cylinder 10 with a configuration described above is explained for a process of a user's sitting on a chair as an example below.

Firstly, as a user sits on a chair and either lifts up or lower down an operation lever (not illustrated) connected with the open pin 14, the open pin 14 is pressed. In addition, when the open pin 14 is pressed down, the switching pin 15 moves down. As the switching pin 15 moves down, the gas stored in the upper chamber 20 moves to the orifice 18 along the side surface of the switching pin 15. In addition, the gas which moved to the orifice 18 moves to the lower chamber 21 through the gas flow path 19. Then, the volume of the lower chamber 21 becomes larger than that of the upper chamber 20 and the spindle 13 falls down. And, when a user removes the force applied to the operation lever, the gas movement does not continue any more. Accordingly, a chair may stay fixed at a user's desired position.

The background technology described above may have been already possessed by the inventor for the presentation of the present invention or may be technology which might have been obtained in the process of the presentation of the present invention, and may not necessarily be determined as common technology open to the general public before filing an application for the present invention.

### SUMMARY

One or more exemplary embodiments include a gas cylinder with improved durability by applying a reinforcement unit with rigidity inside a spindle guide.

Additional aspects will be set forth in part in the description which follows and, in part, will be apparent from the description, or may be learned by practice of the presented embodiments.

According to one or more exemplary embodiments, the gas cylinder may include a base tube including a hollow section, a spindle which is inserted into the hollow section and reciprocatingly moves up and down along the inside circumferential surface of the base tube, a spindle guide which is installed between the base tube and the spindle and guides the moving path of the spindle, and a reinforcement unit installed inside the spindle guide.

In addition, the spindle guide may include a first guide contacting the spindle and a second guide contacting the base tube, and supports the first guide and the reinforcement unit.

In addition, the first guide may include a supporting unit which is formed protruded along the outside circumferential surface.

In addition, the spindle guide may include a first through-hole, and the reinforcement unit may include a second through-hole corresponding to the first through-hole.

In addition, a combining member may be further included which is inserted into the first through-hole as well as the second through-hole, and fastens the spindle guide as well as the reinforcement unit to the base tube.

In addition, the reinforcement unit may include a first protrusion unit, which is protruded inward from the inside circumferential surface of the reinforcement unit, and a first groove with which the first protrusion unit is fitted and combined, while the first guide is formed to correspond to the first protrusion unit on the outside circumferential surface of the reinforcement unit.

In addition, the base tube may include a second protrusion unit, which is protruded inward from the inside circumferential surface of the base tube, and a second groove with which the second protrusion unit is fitted and combined, while the second guide is formed to correspond to the second protrusion unit on the outside circumferential surface of the base tube.

In addition, the reinforcement unit may be manufactured by an insert injection process and installed inside the spindle guide.

In addition, the reinforcement unit may include a plurality of through-holes on the outside circumferential surface thereof.

In addition, the reinforcement unit may include a first reinforcement member installed on the inside of the upper portion of the spindle guide, and a second reinforcement member which is formed separated from the first reinforcement member at a predetermined interval.

In addition, the spindle guide may include an upper guide where at least one portion of the reinforcement unit is accommodated, and a lower guide which accommodates the other portion of the reinforcement unit and is combined with the upper guide.

### BRIEF DESCRIPTION OF THE DRAWINGS

These and/or other aspects will become apparent and more readily appreciated from the following description of the embodiments, taken in conjunction with the accompanying drawings in which:

FIG. 1 is a front cross-sectional view with a partially enlarged view illustrating the structure of a gas cylinder according to an embodiment of the present invention;

FIG. 2 is an exploded perspective view illustrating a spindle guide and a reinforcement unit;

FIG. 3 is a front cross-sectional view with a partially enlarged view illustrating the structure of a gas cylinder according to another embodiment of the present invention;

FIG. 4 is a front cross-sectional view with a partially enlarged view illustrating the structure of a gas cylinder according to another embodiment of the present invention;

FIG. 5 is a front cross-sectional view with a partially enlarged view illustrating the structure of a gas cylinder according to another embodiment of the present invention;

FIG. 6 is a perspective view illustrating a reinforcement unit in FIG. 5;

FIG. 7 is a front cross-sectional view with a partially enlarged view illustrating the structure of a gas cylinder according to another embodiment of the present invention;

FIG. 8 is a front cross-sectional view with a partially enlarged view illustrating the structure of a gas cylinder according to another embodiment of the present invention; and

FIG. 9 is a cross-sectional view illustrating the structure of a conventional gas cylinder.

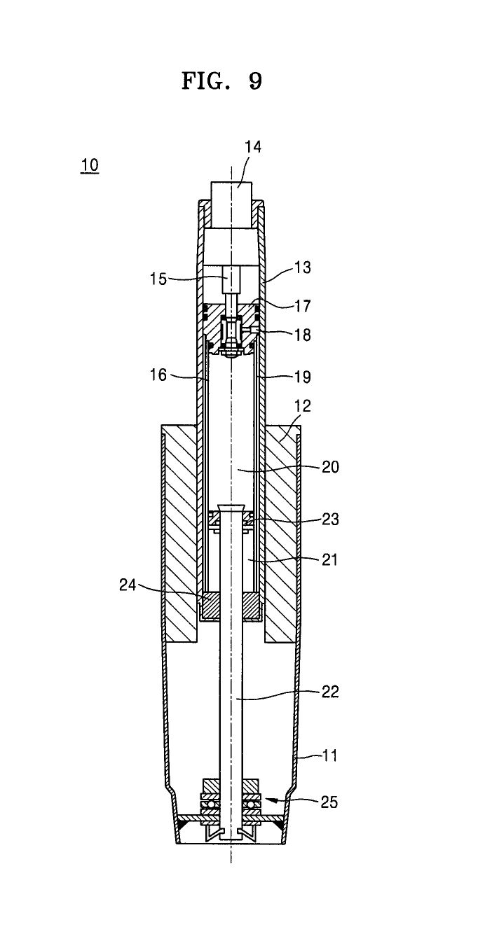

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects of the present description.

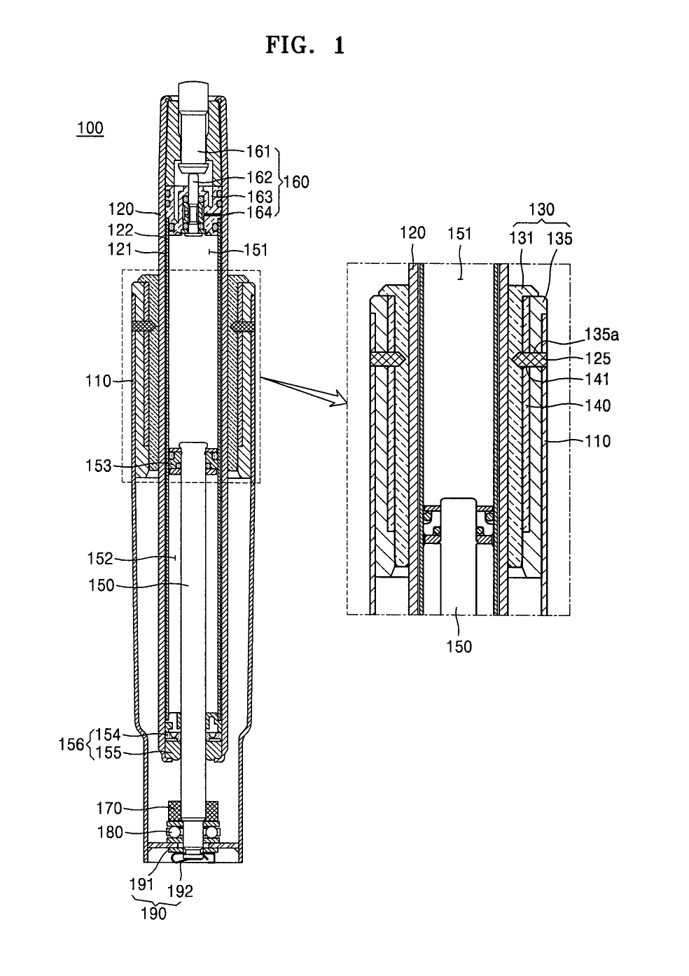

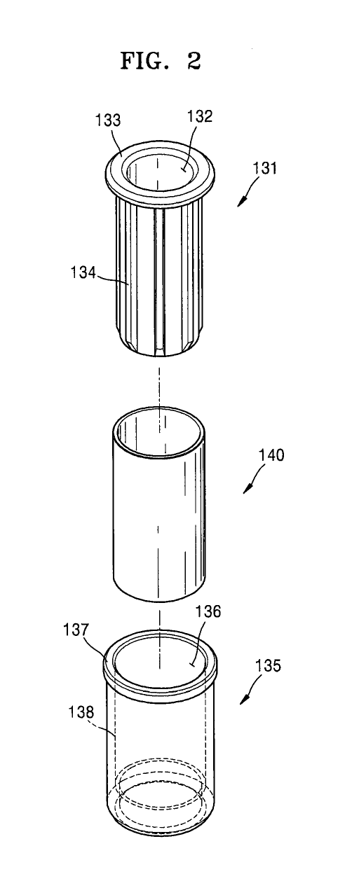

FIG. 1 is a front cross-sectional view with a partially enlarged view illustrating the structure of a gas cylinder 100 according to an embodiment of the present invention, and FIG. 2 is an exploded perspective view illustrating a spindle guide 130 and a reinforcement unit 140.

Referring to FIGS. 1 and 2, the gas cylinder 100 may include a base tube 110, a spindle 120, a spindle guide 130, a reinforcement unit 140, a piston rod 150, a valve unit 160, a buffering member 170, a bearing unit 180 and a fastening member 190 according to an embodiment of the present invention.

The base tube 110 forms the main body of the gas cylinder 100. The base tube 110 contains an internal space and may allow the installation of the spindle 120, the spindle guide 130, the reinforcement unit 140, the piston rod 150, the buffering member 170 and the bearing unit 180 therein.

The spindle 120 may move in a linear movement along the piston rod 150 while being combined with the piston rod 150. In addition, an installation of a cylinder 122 in the internal space of the spindle 120 may generate an up-and-down movement of the spindle 120 due to the volume changes in an upper gas chamber 151 and a lower gas chamber 152. The valve unit 160 may be installed at the upper end portion of the spindle 120 to control the gas movement between the upper gas chamber 151 and the lower gas chamber 152, and a sealing member 156 may be installed at the lower end portion of the spindle 120 to prevent the gas leakage toward the bottom side of the cylinder 122. The sealing member 156 may include a gas sealing 154 maintaining a sealing of the upper gas chamber 151 and the lower gas chamber 152, and a flange 155 installed at the bottom side of the gas sealing 154. The flange 155 may reduce the impact on the buffering member 170 during the falling movement of the spindle 120 and enhance the durability of the spindle 120.

The spindle guide 130 may be installed between the base tube 110 and the spindle 120, and guide the moving path of the spindle 120. The spindle guide 130 may have a pipe shape extended in the longitudinal direction of the spindle 120. The spindle guide 130 may include a first guide 131 installed inside the reinforcement unit 140 and a second guide 135 installed outside the reinforcement unit 140.

The inside circumferential surface of the first guide 131 is installed to be in contact with the spindle 120, and the outside circumferential surface of the first guide 131 is installed to be in contact with the reinforcement unit 140. The first guide 131 may include a first hollow section 132, a first flange 133 and a supporting unit 134.

The spindle 120 is inserted into the first hollow section 132 and may generate an up-and-down reciprocating movement in the longitudinal direction of the base tube 110. The diameter of the first hollow section 132 is formed almost as same as the outside diameter of the spindle 120. Thus, the spindle guide 130 may maintain a linear movement for the moving direction of the spindle 120 during an up-and-down reciprocating movement of the spindle 120.

The first flange 133 may be formed at one end of the first guide 131. The first flange 133 may be formed protruded from the outer circumferential surface of the first guide 131, and may be visible from the outside when installed on the gas cylinder 100. The first flange 133 may be formed to cover at least a portion of the second guide 135 or the reinforcement unit 140. The first flange 133 may firmly combine the first guide 131 and the second guide 135, and prevent a separation of the reinforcement unit 140 installed inside.

The supporting unit 134 may be formed protruded along the outside circumferential surface of the first guide 131. A plurality of the supporting units 134 may be installed along the outside circumferential surface of the first guide 131. The supporting units 134 may be formed protruded in the longitudinal direction of the spindle 120 and installed at a predetermined interval from the adjacent supporting units 134. In addition, although not illustrated on the drawing, the supporting units 134 may be formed to have a ring shape protruded along the outside circumferential surface of the first guide 131, and be formed at a predetermined interval from the adjacent supporting units 134 in the longitudinal direction of the spindle 120. For explanatory convenience, a case is described below where the supporting unit 134 is formed protruded along the longitudinal direction of the spindle 120.

The supporting unit 134 may be in contact with the inside circumferential surface of the reinforcement unit 140. In detail, the distance from the center of the first guide 131 to the outer edge of the supporting unit 134 may be formed either as same as or longer than that from the center of the reinforcement unit 140 to the inside circumferential surface thereof. Here, the first guide 131 and the reinforcement unit 140 are combined by tight fit, and the combination of the first guide 131 and the reinforcement unit 140 may be solid. Thus, the deformation of the reinforcement unit 140 and the spindle guide 130, which is generated when a user presses down the spindle, may be minimized. In addition, a groove may be formed between one supporting unit 134 and another adjacent supporting unit 134, and the material cost of manufacturing the spindle guide 130 may be reduced.

The second guide 135 may be installed in such a way that the inside circumferential surface of the second guide 135 is in contact with either the first guide 131 or the reinforcement unit 140 and the outside circumferential surface of the second guide 135 is in contact with the base tube 110. The second guide 135 may maintain the first guide 131 and the reinforcement unit 140 to be supported by the base tube 110. The second guide 135 may include a second hollow section 136, a second flange 137 and a seating section 138.

The second hollow section 136 may be formed in such a way that the reinforcement unit 140 or the first guide 131 may be inserted. The second hollow section 136 may be formed to have a step due to different diameter of the inside circumferential surface of the second guide 135 in order to include the seating section 138. In other words, the seating section 138 may be formed concave in the radial direction of the base tube 110 on the inside circumferential surface of the second guide 135. Here, the reinforcement unit 140 may be supported by the surface-contact with the seating section 138.

The second flange 137 also may be formed at one end of the second guide 135, similarly to the first flange 133. The second flange 137 may be formed protruded from the outside circumferential surface of the second guide 135, and may be visible from the outside when installed on the gas cylinder 100. The second flange 137 may be formed to be in contact with the first flange 133 of the first guide 131, and solidly fix the reinforcement unit 140 installed between the first guide 131 and the second guide 135. In addition, the second flange 137 may be supported by one end of the base tube 110 and solidly fix the first guide 131 and the second guide 135 to the base tube 110.

The second guide 135 may be formed to have a step on the circumferential surface thereof in order to have at least one catching protrusion. The seating section 138 may be in surface-contact with the reinforcement unit 140, and the end edge of the reinforcement unit 140 may be supported by the catching protrusion. In detail, the seating section 138 may have a depth corresponding to the thickness of the reinforcement unit 140 in order to install the reinforcement unit 140 on the inside circumferential surface of the second guide 135, and form a groove with a length corresponding to that of the reinforcement unit 140 in the longitudinal direction of the spindle 120.

The reinforcement unit 140 may be installed inside the spindle guide 130 and increase the rigidity of the spindle guide 130. In other words, the reinforcement unit 140 may be installed between the first guide 131 and the second guide 135, and may minimize the deformation of the spindle 120 due to an external force.

The reinforcement unit 140 may be formed by using a material different from that of the first guide 131 or the second guide 135. The reinforcement unit 140 may use a material with rigidity and is not limited to a particular material. For example, the reinforcement unit 140 may utilize a metallic material such as iron, aluminum, and copper, or a non-metallic material such as a natural resin and a synthetic resin.

A combining member 125 may be used to combine the spindle guide 130 and the reinforcement unit 140 with the base tube 110. The combining member 125 may be a member to combine different structures and may not be limited to a particular configuration or combining method. For example, the combining member 125 may have a shape of a spring pin, a screw, a rivet, a nail, etc., and a combining method of welding, tight fit, etc. For explanatory convenience, a case is described below where the combining member 125 has a shape of a spring pin and employs a combining method of tight fit.

The spindle guide 130 may include a first through-hole 135a and the reinforcement unit 140 may include a second through-hole 141 corresponding to the first through-hole 135a. The combining member 125 may be inserted into the first through-hole 135a as well as the second through-hole 141, and fix the spindle guide 130 and the reinforcement unit 140 to the base tube 110.

The piston rod 150 may be inserted into the base tube 110 and supported by the fastening member 190. In detail, a fastening clip 192 is combined at the bottom end portion of the piston rod 150, and the piston rod 150 may be prevented from being disassembled from the base tube 110. A clip washer 191 may be inserted between the base tube 110 and the fastening clip 192, and prevent a phenomenon that a fixed plate of the base tube 110 is damaged due to a direct contact with the fastening clip 192.

The internal space of the cylinder 122 may be divided into the upper gas chamber 151 and the lower gas chamber 152 by a piston 153 installed at the top end of the piston rod 150. A gas flow path 121 may be formed, between the outside circumferential surface of the cylinder 122 and the inside circumferential surface of the spindle 120, so that the gas may move between the upper gas chamber 151 and the lower gas chamber 152. The spindle 120 may move up and down along the piston rod 150 as the volumes of the upper gas chamber 151 and the lower gas chamber 152 change due to the gas moving through the gas flow path 121.

A valve unit 160 may be formed, at the upper end portion of the cylinder 122, which seals the upper side portion of the cylinder 122 and controls the in-and-out movement of the gas. The valve unit 160 may include an open pin 161, a switching pin 162, a pipe holder 163 and an orifice 164.

In detail, the pipe holder 163 may seal the upper side portion of the cylinder 122 and have a hollow section inside the pipe holder 163. The switching pin 162 may be installed through a hollow section of the pipe holder 163 and control the in-and-out movement of the gas inside the cylinder 122. The open pin 161 may be seated at the upper side portion of the switching pin 162 and apply a pressure to the switching pin 162. The orifice 164 may be formed inside the pipe holder 163, and allow the charged gas inside the cylinder 122 to move through the inside of the cylinder 122 and the gas flow path 121.

The buffering member 170 may be installed between the spindle 120 and the bearing unit 180, and absorb an impact during a linear movement of the spindle 120. In other words, the impact may be alleviated which is generated by a collision between the bottom portion of the spindle 120 and the bearing unit 180 when the spindle 120 moves down. In addition, the noise generated by the spindle 120 hitting the bearing unit 180 may be reduced, and the durability of the bearing unit 180 may be improved. The bearing unit 180 may be installed at the bottom portion of the piston rod 150, and support the piston rod 150 while simultaneously allowing a rotational movement of the piston rod 150.

When a user sits on a chair, the spindle 120 may slightly move down due to a load of the user's weight. Then, the volume of the upper gas chamber 151 may be reduced and the gas pressure inside the cylinder 122 may increase. In other words, a pressure, formed in the cylinder 122 before a user sits on a chair, added by the load is applied to the upper gas chamber 151.

When the operation lever (not illustrated) connected with the open pin 161 is either pressed down or lifted up, the open pin 161 moves down. Since the open pin 161 maintains a contact with the switching pin 162, the switching pin 162 also moves down due to the downward movement of the open pin 161. Since the switching pin 162 closes the orifice 164 connected with the inside of the cylinder 122 before the operation lever is moved, the downward movement of the open pin 161 causes the inside of the cylinder 122 and the orifice 164 to be connected.

Since the orifice 164 is connected with the gas flow path 121, the pressurized gas inside the upper gas chamber 151 passes through the orifice 164 and the gas flow path 121, and moves to the lower gas chamber 152. Then, the volume of the upper gas chamber 151 decreases and that of the lower gas chamber 152 increases, and the spindle 120 as well as the cylinder 122 move down.

An upward movement of the spindle 120 as well as the cylinder 122 is similar to the downward movement described above. When the operation lever (not illustrated) connected with the open pin 161 is either pressed down or lifted up, the orifice 164 becomes open due to the downward movement of the open pin 161 and the switching pin 162. When the user stands up from a chair and the load corresponding to the user's weight is removed, the pressurized gas inside the lower gas chamber 152 may move to the upper gas chamber 151 through the gas flow path 121. Then, the volume of the upper gas chamber 151 increases and the volume of the lower gas chamber 152 decreases, and the spindle 120 as well as the cylinder 122 move up.

As described above, the spindle 120 as well as the cylinder 122 may reciprocatingly move up and down due to the volume change in the upper gas chamber 151 and the lower gas chamber 152, caused by an application of force in up-and-down directions. A user may apply a force in a direction different from the longitudinal direction of the spindle 120 during the up-and-down movement of the spindle 120. In addition, a user may apply a force in a direction different from the longitudinal direction of the spindle 120 after the height of the spindle 120 is fixed. For example, a user may move forward and backward, or left and right at the same time when a user sits on a chair. Then, the external force in a direction different from the longitudinal direction of the spindle 120 may be transferred to the gas cylinder 100. The spindle 120 may transfer the external force to the spindle guide 130 and apply it to the spindle guide 130 or the base tube 110.

The external force described above may cause a separation space between the spindle 120 and the spindle guide 130, and a repetitive application of the external force may reduce the durability of the gas cylinder 100. In other words, a wobble phenomenon, where the spindle 120 shakes during up-and-down movement, may happen, and the stability of the gas cylinder 100 may be reduced.

Especially, the wobble phenomenon may happen on a large scale when the spindle 120 is at a high position. The main cause of the wobble phenomenon is the bending moment due to the external force applied in a direction perpendicular to the longitudinal direction of the spindle 120. Thus, when the spindle 120 is at a high position from the base tube 110, the distance, from the spindle guide 130 to a point where the external force is applied, increases and the bending moment accordingly increases. As a result, the wobble phenomenon may happen on a large scale.

In addition, shaking and vibration of the spindle 120 during a user's sitting on a chair may disrupt comfortableness, and a noise may be generated due to a friction between the spindle 120 and the spindle guide 130. In addition, a repetitive application of the external force may cause a damage to the spindle guide 130 and a user may need to either replace or repair the spindle guide 130.

In order to solve such problems above, the gas cylinder 100 may include the spindle guide 130 with the reinforcement unit 140 inside the spindle guide 130 according to an embodiment of the present invention. The spindle guide 130 may include the reinforcement unit 140 inside the spindle guide 130 and enhance the durability of the spindle guide 130. In other words, an installation of the reinforcement unit 140 inside the spindle guide 130 may prevent the deformation and the wobble phenomenon of the spindle guide 130 due to the repetitive external force.

In addition, even when the external force due to a user's sitting as well as moving is transferred to the spindle guide 130 by the spindle 120, the damage as well as the vibration of the spindle guide 130 may be minimized, and the durability of the gas cylinder 100 may be enhanced.

In addition, the spindle guide 130 may be separated into the first guide 131 and the second guide 135, and thus, the maintenance and the replacement as well as the repair of the gas cylinder 100 may become easier. The first guide 131 may include the supporting unit 134 to enhance the combination force with the reinforcement unit 140 and reduce material cost. The second guide 135 may seat the reinforcement unit 140 to the seating section 138 and solidify the combination of the spindle guide 130 and the reinforcement unit 140.

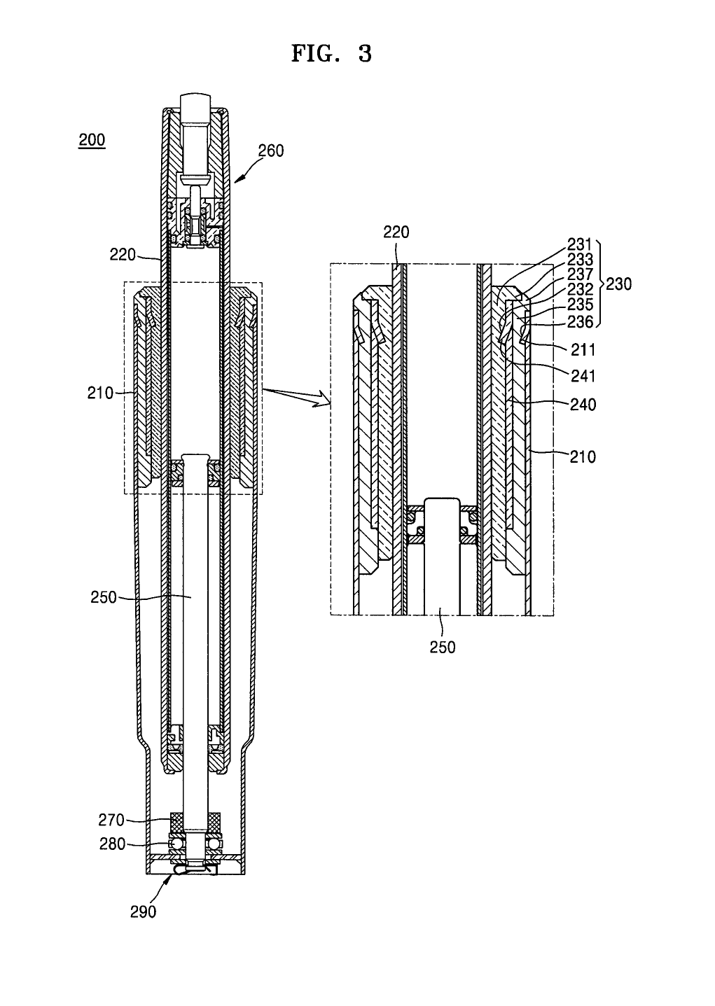

FIG. 3 is a front cross-sectional view with a partially enlarged view illustrating the structure of a gas cylinder 200 according to another embodiment of the present invention.

Referring to FIG. 3, the gas cylinder 200 may include a base tube 210, a spindle 220, a spindle guide 230, a reinforcement unit 240, a piston rod 250, a valve unit 260, a buffering member 270, a bearing unit 280, and a fastening member 290 according to another embodiment of the present invention. All parts of another embodiment of the present invention are the same as those of an embodiment of the present invention, except the shape and the fastening method of the spindle guide 230 as well as the reinforcement 240 are distinctively different. Therefore, parts without description in another embodiment of the present invention may be invoked from those in an embodiment of the present invention, and the detailed description thereof is omitted.

The spindle guide 230 may be installed between the base tube 210 and the spindle 220, and guide the movement path of the spindle 220. The spindle guide 230 may include a first guide 231 installed inside the reinforcement unit 240 and a second guide 235 installed outside the reinforcement unit 240.

The reinforcement unit 240 may include a first protrusion unit 241 protruded toward the spindle 220 on the inside circumferential surface of the reinforcement unit 240. The protrusion direction, the shape, or the number of the first protrusion unit 241 may not be limited to particular direction, shape or number, and may vary per a designer's design. For example, the protrusion unit 241 may be formed at a predetermined angle either upward or downward, and be perpendicularly protruded on the inside circumferential surface of the protrusion unit 241. In addition, the protrusion unit 241 may have a sharp pinnacle shape or a curvature in a round shape. In addition, the protrusion unit 241 may be included in a plural number along the inside circumferential surface of the reinforcement unit 240, and formed in a radial shape from the center of the reinforcement unit 240. For explanatory convenience, a case is described below where the reinforcement unit 240 may include a plurality of the protrusion units 241 at a predetermined angle downwards and in a sharp shape.

The first guide 231 may be formed to correspond to the first protrusion unit 241 on the outside circumferential surface of the first guide 231, and include a first groove 232 with which the first protrusion unit 241 is fitted and combined. In other words, the first guide 231 may support one side of the reinforcement unit 240 with a first flange 233, and the other side of the reinforcement unit 240 with the first groove 232 where the first protrusion unit 241 is inserted.

The base tube 210 may include a second protrusion unit 211 protruded toward the spindle 220 on the inside circumferential surface of the base tube 210. The second guide 235 may be formed to correspond to the second protrusion unit 211 of the base tube 210 on the outside circumferential surface of the second guide 235, and include a second groove 236 with which the second protrusion unit 211 is fitted and combined. The shape and the combination method of the second protrusion unit 211 as well as the second groove 236 are either identical or almost similar to those, respectively described above, of the first protrusion unit 241 of the reinforcement unit 240 as well as the first groove 232 of the first guide 231, and the detailed description thereof is omitted.

In other words, one side of the second guide 235 may be supported by the base tube 210 with the second flange 237, and the other side of the second guide 235 may be supported by the base tube 210 with the second groove 236 where the second protrusion unit 211 is inserted.

In addition, at least a portion of the first flange 233 of the first guide 231 may be accommodated by the second flange 237 of the second guide 235. Since the first flange 233 may be supported by a catching protrusion formed by the second flange 237, the combination of the first guide 231 and the second guide 235 may be solid, and the deformation of the spindle guide 230 due to the external force may be minimized.

The spindle guide 230 may include the reinforcement unit 240 inside the spindle guide 230, and the deformation of the spindle guide 230 due to the repetitive external force by a user may be prevented. In addition, the wobble phenomenon where the gas cylinder 230 is shaking during the up-and-down movement of the spindle 220 may be minimized, and a user during sitting may feel comfortable without a shaking of the spindle 220. In other words, the spindle guide 230 including the reinforcement unit 240 may enhance the stability as well as the durability of the gas cylinder 200.

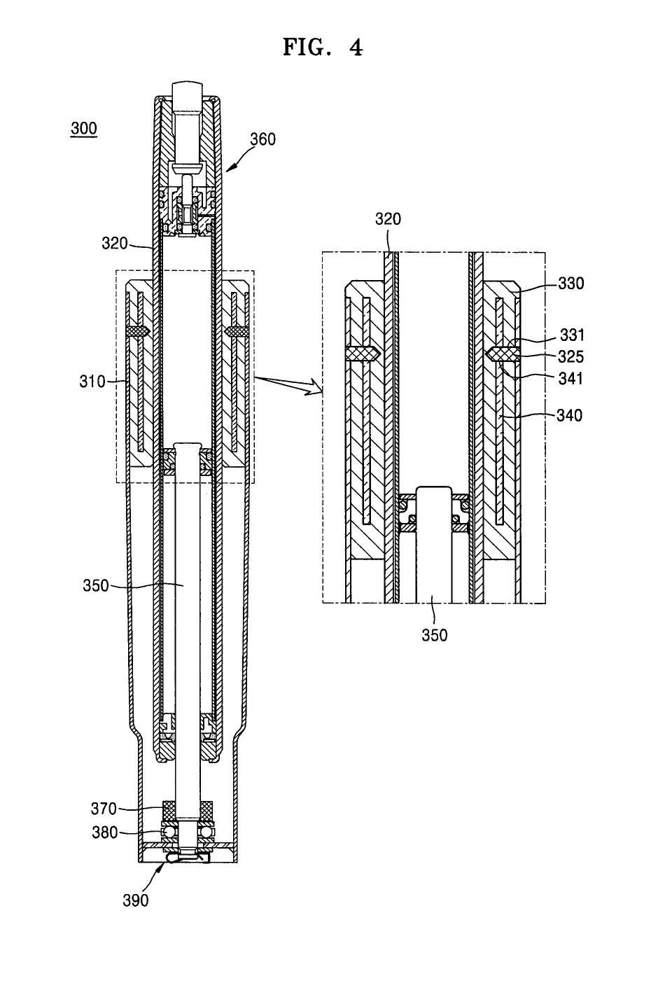

FIG. 4 is a front cross-sectional view with a partially enlarged view illustrating the structure of a gas cylinder 300 according to another embodiment of the present invention.

Referring to FIG. 4, the gas cylinder 300 may include a base tube 310, a spindle 320, a spindle guide 330, a reinforcement unit 340, a piston rod 350, a valve unit 360, a buffering member 370, a bearing unit 380, and a fastening member 390 according to another embodiment and modified embodiment of the present invention. All parts of another embodiment of the present invention are the same as those of an embodiment of the present invention, except the shape of the spindle guide 330 is distinctively different. Therefore, parts without description in another embodiment of the present invention may be invoked from those in an embodiment of the present invention, and the detailed description thereof is omitted.

The spindle guide 330 may be formed as one body including the reinforcement unit 340 inside the spindle guide 330. In other words, the reinforcement unit 340 may be installed inside the spindle guide 330, and the reinforcement unit 340 and the spindle guide 330 may be used as a unit. In addition, the spindle guide 330 and the reinforcement unit 340 may be manufactured by the insert injection process.

The spindle guide 330 and the reinforcement unit 340 may be combined with the base tube 310 using a combining member 325. A first through-hole 331 may be formed in the spindle guide 330 and a second through-hole 341 corresponding to the first through-hole 331 may be formed in the reinforcement unit 340, and the spindle guide 330 and the reinforcement unit 340 may be combined by inserting the combining member 325 through the first through-hole 331 and the second through-hole 341.

The spindle guide 330 may include the reinforcement unit 340 inside the spindle guide 330 and the deformation of the spindle guide 330 due to the repetitive external force by a user may be prevented. In addition, since the spindle 320 may be supported with a minimized gap between the spindle 320 and the spindle guide 330, a user during sitting may feel comfortable without a shaking of the spindle 320.

The spindle guide 330 and the reinforcement unit 340 may be formed as one body, and the spindle guide 330 and the reinforcement unit 340 may be more solidly combined. Thus, even when the external force due to a user's sitting as well as moving is transferred to the spindle guide 330 by the spindle 320, the damage as well as the vibration of the spindle guide 330 may be minimized, and the durability as well as the stability of the gas cylinder 300 may be enhanced.

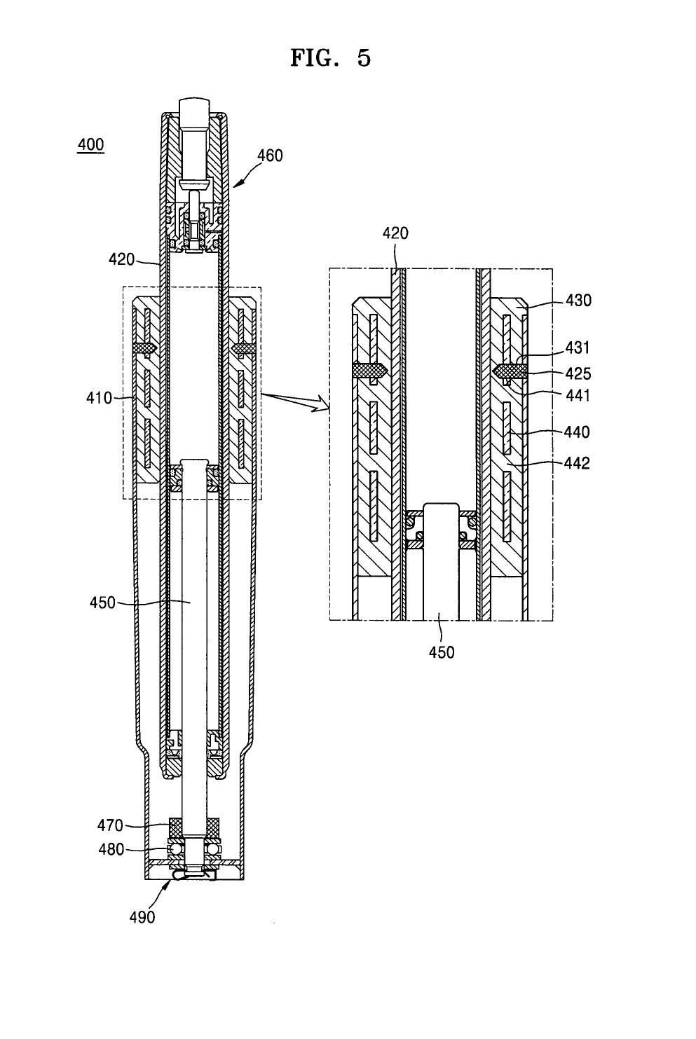

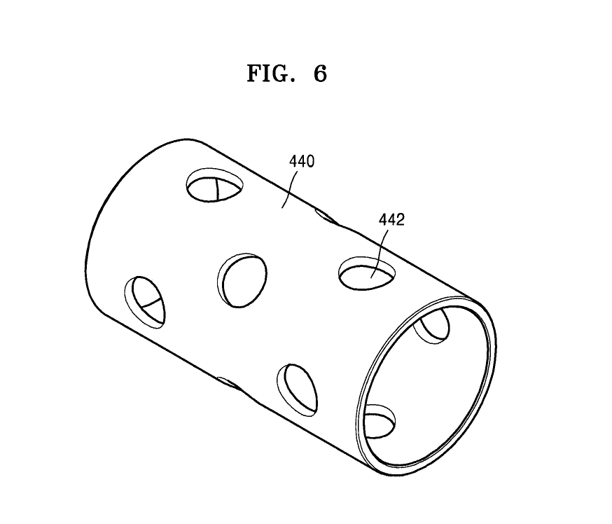

FIG. 5 is a front cross-sectional view with a partially enlarged view illustrating the structure of a gas cylinder 400 according to another embodiment of the present invention, and FIG. 6 is a perspective view illustrating a reinforcement unit 440 in FIG. 5.

Referring to FIGS. 5 and 6, the gas cylinder 400 may include a base tube 410, a spindle 420, a spindle guide 430, a reinforcement unit 440, a piston rod 450, a valve unit 460, a buffering member 470, a bearing unit 480, and a fastening member 490 according to another embodiment and modified embodiment of the present invention. All parts of another embodiment of the present invention are the same as those of an embodiment of the present invention, except the shape of the reinforcement unit 440 is distinctively different. Therefore, parts without description in another embodiment of the present invention may be invoked from those in an embodiment of the present invention, and the detailed description thereof is omitted.

The spindle guide 430 may be formed as one body including the reinforcement unit 440 inside the spindle guide 430. In other words, the reinforcement unit 440 may be installed inside the spindle guide 430, and the reinforcement unit 440 and the spindle guide 430 may be used as a unit. In addition, the spindle guide 430 and the reinforcement unit 440 may be manufactured by the insert injection process.

The reinforcement unit 440 may include a plurality of through-holes 442 on the outside circumferential surface thereof. The spindle guide 430 may pass through the through-holes 442 of the reinforcement unit 440 to combine with the reinforcement unit 440. In other words, when the spindle guide 430 and the reinforcement unit 440 are formed, the spindle guide 430 may pass through the through-holes 442 to combine with the reinforcement unit 440. After the spindle guide 430 passes through the through-holes 442, the contact area between the spindle guide 430 and the reinforcement unit 440 may increase, and the combining force may be enhanced. Bubbles may be generated inside the spindle guide 430 and the reinforcement unit 440 due to the non-uniform material flow during the insert injection process. However, since the spindle guide 430 may be insert injected through the through-holes 442, the material flow of the spindle guide 430 may be good, and the bubble generation may be minimized which may occur inside the spindle guide 430 or on the surface of the reinforcement unit 440.

The spindle guide 430 and the reinforcement unit 440 may be combined with the base tube 410 using a combining member 425. A first through-hole 431 may be formed in the spindle guide 430 and a second through-hole 441 corresponding to the first through-hole 431 may be formed in the reinforcement unit 440, and the spindle guide 430 and the reinforcement unit 440 may be combined by inserting the combining member 425 through the first through-hole 431 and the second through-hole 441.

The spindle guide 430 may include the reinforcement unit 440 inside the spindle guide 430 and the deformation of the spindle guide 430 due to the repetitive external force by a user may be prevented. In addition, since the spindle 420 may be supported with a minimized gap between the spindle 420 and the spindle guide 430, a user during sitting may feel comfortable without a shaking of the spindle 420.

The spindle guide 430 may pass through the through-hole 442 and the spindle guide 430 and the reinforcement unit 440 may be more solidly combined as one body. Thus, even when the external force due to a user's sitting as well as moving is transferred to the spindle guide 430 by the spindle 420, the damage as well as the vibration of the spindle guide 430 may be minimized, and the durability as well as the stability of the gas cylinder 400 may be enhanced.

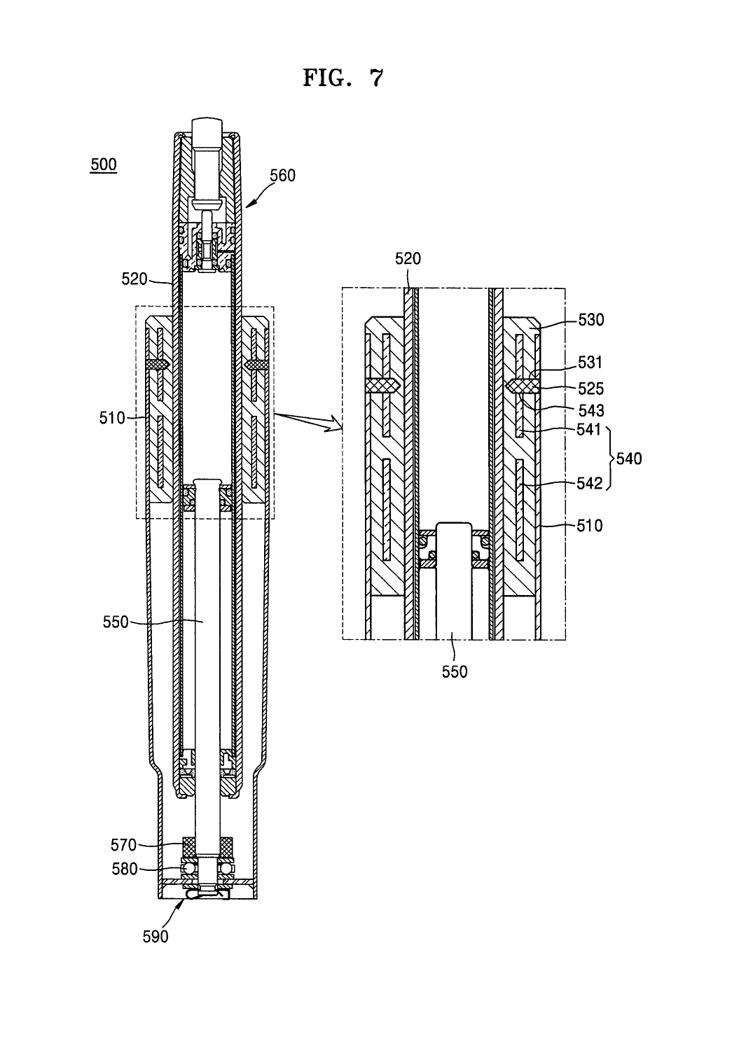

FIG. 7 is a front cross-sectional view with a partially enlarged view illustrating the structure of a gas cylinder 500 according to another embodiment of the present invention.

Referring to FIG. 7, the gas cylinder 500 may include a base tube 510, a spindle 520, a spindle guide 530, a reinforcement unit 540, a piston rod 550, a valve unit 560, a buffering member 570, a bearing unit 580, and a fastening member 590 according to another embodiment of the present invention. All parts of another embodiment of the present invention are the same as those of an embodiment of the present invention, except the shape of the reinforcement unit 540 is distinctively different. Therefore, parts without description in another embodiment of the present invention may be invoked from those in an embodiment of the present invention, and the detailed description thereof is omitted.

The spindle guide 530 may be formed as one body including the reinforcement unit 540 inside the spindle guide 530. In other words, the reinforcement unit 540 may be installed inside the spindle guide 530, and the reinforcement unit 540 and the spindle guide 530 may be used as a unit. In addition, the spindle guide 530 and the reinforcement unit 540 may be manufactured by the insert injection process.

The spindle guide 530 and the reinforcement unit 540 may be combined with the base tube 510 using a combining member 525. A first through-hole 531 is formed in the spindle guide 530 and a second through-hole 543 corresponding to the first through-hole 531 may be formed in the reinforcement unit 540, and the spindle guide 530 and the reinforcement unit 540 may be combined by inserting the combining member 525 through the first through-hole 531 and the second through-hole 543.

A plurality of the reinforcement units 540 may be included, and the number of the reinforcement units 540 may be determined by a designer's convenience. The reinforcement units 540 may be formed for larger contact area with the spindle guide 530. The reinforcement units 540 may be formed in a radial shape, around the inside of the spindle guide 530, in the longitudinal direction of the spindle 520. In addition, a plurality of the reinforcement units 540 may be installed in a ring shape in the longitudinal direction of the spindle 520 at a predetermined interval. For explanatory convenience, a case is described where two ring-shaped reinforcement units 540 are installed in parallel in the longitudinal direction of the spindle 520.

The reinforcement unit 540 may include a first reinforcement member 541 and a second reinforcement member 542. The first reinforcement member 541 may be installed inside the upper side of the spindle guide 530, and the second reinforcement member 542, separated from the first reinforcement member 541 at a predetermined interval, may be installed at the lower side of the first reinforcement member 541.

When the spindle guide 530 and the reinforcement unit 540 are formed, the spindle guide 530 and the reinforcement unit 540 may be manufactured by passing the spindle guide 530 through between the first reinforcement member 541 and the second reinforcement member 542. In this case, the contact area between the spindle guide 530 and the reinforcement unit 540 may increase, and the combination force between the spindle guide 530 and the reinforcement unit 540 may be enhanced. In addition, since the material flow of the spindle guide 530 may be good while the spindle guide 530 and the reinforcement unit 540 are formed, the bubble generation may be minimized which may occur during the insert injection process.

The spindle guide 530 may include the reinforcement unit 540 thereof and the deformation of the spindle guide 530 due to the repetitive external force by a user may be prevented. In addition, since the spindle 520 may be supported with a minimized gap between the spindle 520 and the spindle guide 530, the wobble phenomenon may be minimized. A user during sitting on a chair including the gas cylinder 500 may feel comfortable without a shaking of the spindle 520.

The spindle guide 530 and the reinforcement unit 540 may be formed as one body, and the spindle guide 530 and the reinforcement unit 540 may be more solidly combined. Thus, even when the external force due to a user's sitting as well as moving is transferred to the spindle guide 530 by the spindle 520, the damage as well as the vibration of the spindle guide 530 may be minimized, and the durability as well as the stability of the gas cylinder 500 may be enhanced.

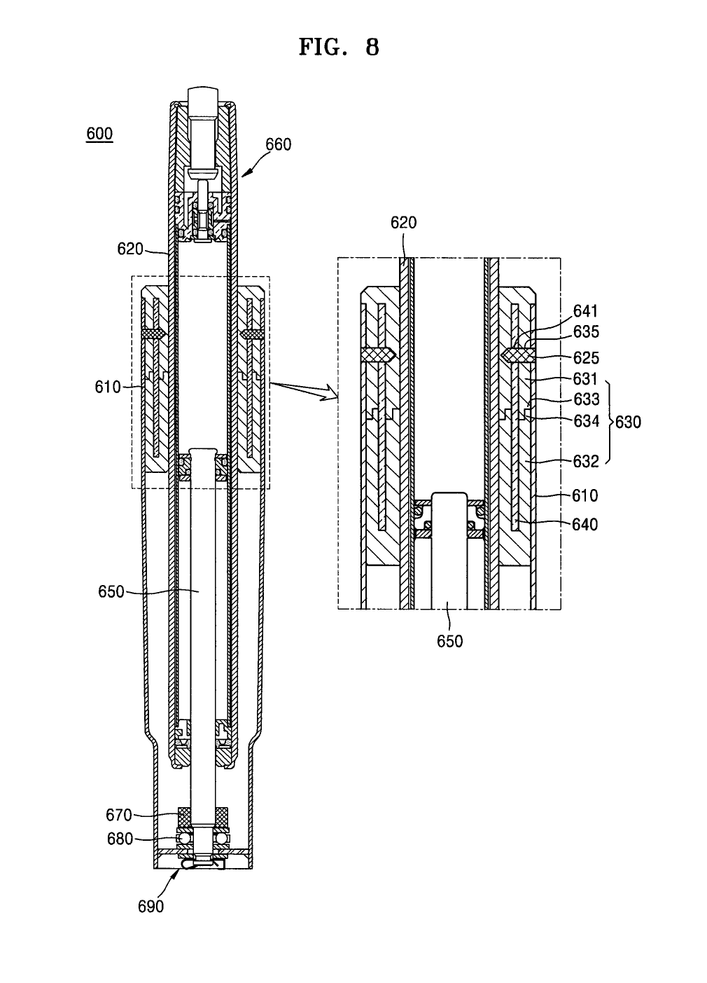

FIG. 8 is a front cross-sectional view with a partially enlarged view illustrating the structure of a gas cylinder 600 according to another embodiment of the present invention.

Referring to FIG. 8, the gas cylinder 600 may include a base tube 610, a spindle 620, a spindle guide 630, a reinforcement unit 640, a piston rod 650, a valve unit 660, a buffering member 670, a bearing unit 680, and a fastening member 690 according to another embodiment of the present invention. All parts of another embodiment of the present invention are the same as those of an embodiment of the present invention, except the combination method of the spindle guide 630 is distinctively different. Therefore, parts without description in another embodiment of the present invention may be invoked from those in an embodiment of the present invention, and the detailed description is omitted.

The spindle guide 630 may be formed to include the reinforcement unit 640 therein, and an upper guide 631 and a lower guide 632 which are installed in the longitudinal direction of the spindle 620. The upper guide 631 may be formed to accommodate at least a portion of the reinforcement unit 640. The lower guide 632 may accommodate the other portion of the reinforcement unit 640, and be combined with the upper guide 631.

The upper guide 631 and the lower guide 632 may include, in their internal space, a slot which the reinforcement unit 640 may be inserted into. The slot may be intermittently formed in a plurality of numbers inside the spindle guide 630 and be formed by a plurality of the reinforcement units 640 which may be correspondingly inserted into the slots. In addition, the slot may be continuously formed along the internal space of the spindle guide 630, and the reinforcement unit 640 with a radial shape may be inserted and combined. For explanatory convenience, a case is described where the reinforcement unit 640 with a radial shape is inserted to and combined with the upper guide 631 and the lower guide 632.

The spindle guide 630 and the reinforcement unit 640 may be combined by press-fitting the upper guide 631 after the reinforcement unit 640 is inserted into the inside of the lower guide 632. In this case, the upper guide 631 and the lower guide 632 may include a concave unit 633 and a protrusion unit 634 corresponding to the concave unit 633, respectively, and the concave unit 633 and the protrusion unit 634 may be well combined together.

The spindle guide 630 and the reinforcement unit 640 may be combined with the base tube 610 using a combining member 625. A first through-hole 635 is formed in the spindle guide 630 and a second through-hole 641 corresponding to the first through-hole 635 may be formed in the reinforcement unit 640, and the spindle guide 630 and the reinforcement unit 640 may be combined by inserting the combining member 625 through the first through-hole 635 and the second through-hole 641.

The spindle guide 630 may include the reinforcement unit 640 therein and the deformation of the spindle guide 630 due to the repetitive external force by a user may be prevented. In addition, since the spindle 620 may be supported with a minimized gap between the spindle 620 and the spindle guide 630, the wobble phenomenon may be minimized. A user during sitting on a chair including the gas cylinder 600 may feel comfortable without a shaking of the spindle 620. Since a plurality of the spindle guides 630 may be included for separability, the replacement as well as the repair of the spindle guides 630 may be simple and easy.

As described above, according to the one or more of the above exemplary embodiments, the deformation of the spindle guide due to the repetitive outside force applied by a user may be prevented by applying the reinforcement unit inside the spindle guide. In addition, since the spindle guide supports the spindle, a user may feel comfortable, while being seated, without the wobble of the spindle.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A gas cylinder comprising:
a base tube with a hollow section;
a spindle, inserted into the hollow section, generating an up-and-down, reciprocating movement along an inside circumferential surface of the base tube;
a spindle guide, installed between the base tube and the spindle, guiding a moving path of the spindle; and
a reinforcement unit installed inside the spindle guide.

2. The gas cylinder of claim 1, wherein the spindle guide comprises:
a first guide in contact with the spindle; and
a second guide, in contact with the base tube, supporting the first guide and the reinforcement unit.

3. The gas cylinder of claim 2, wherein the first guide comprises a supporting unit formed protruded along an outside circumferential surface thereof.

4. The gas cylinder of claim 2, wherein the second guide comprises a seating section formed concave in the radial direction of the base tube on an inside circumferential surface of the second guide and the reinforcement unit is supported by a surface-contact with the seating section.

5. The gas cylinder of claim 4, wherein the first guide comprises a first flange formed protruded at one end thereof, and the first flange covers at least one of the second guide and the reinforcement unit.

6. The gas cylinder of claim 1, wherein the spindle guide comprises a first through-hole and the reinforcement unit comprises a second through-hole corresponding to the first through-hole, and the gas cylinder further comprises a combining member, inserted into the first through-hole as well as the second through-hole, fastening the spindle guide and the reinforcement unit to the base tube.

7. The gas cylinder of claim 2, wherein the reinforcement unit comprises a first protrusion unit protruded toward the spindle on an inside circumferential surface of the reinforcement unit, and the first guide comprises a first groove formed to correspond to the first protrusion unit on the outside circumferential surface of the first guide, and fitted and combined with the first protrusion unit.

8. The gas cylinder of claim 2, wherein the base tube comprises a second protrusion unit protruded toward the spindle on the inside circumferential surface of the base tube, and the second guide comprises a second groove formed to correspond to the second protrusion unit on the outside circumferential surface of the second guide, and fitted and combined with the second protrusion unit.

9. The gas cylinder of claim 1, wherein the reinforcement unit is insert-injected and installed inside the spindle guide.

10. The gas cylinder of claim 1, wherein the reinforcement unit comprises a plurality of through-holes on an outside circumferential surface thereof.

11. The gas cylinder of claim 1, wherein the reinforcement unit comprises:
a first reinforcement member installed inside the upper side of the spindle guide; and
a second reinforcement member formed, at a predetermined interval, with the first reinforcement member.

12. The gas cylinder of claim 1, wherein the spindle guide comprises:
an upper guide accommodating at least one portion of the reinforcement unit; and
a lower guide accommodating the other portion of the reinforcement unit and being combined with the upper guide.
